(19) United States
(12) Patent Application Publication
(10) Pub. No.: US 2022/0188376 A1
(43) Pub. Date: Jun. 16, 2022

(54) SYSTEM AND METHOD OF EMBEDDING SEGMENTS OF A WEBPAGE

(71) Applicant: RADICAL HQ LIMITED, London (GB)

(72) Inventors: Thomas Petty, London (GB); Andrei Gheorghe, London (GB); Katricia Olearczyk-Reid, London (GB); Sven Over, London (GB); Henry Davies, London (GB); Jackson Gabbard, London (GB); Nimrod Priell, London (GB); Abigail Barsky, Atlanta, GA (US)

(21) Appl. No.: 17/326,029

(22) Filed: May 20, 2021

Related U.S. Application Data
(60) Provisional application No. 63/125,710, filed on Dec. 15, 2020.

(51) Int. Cl. G06F 16/957; G06F 16/11; G06F 16/13

(52) U.S. Cl. CPC G06F 16/9577; G06F 16/13; G06F 16/116; G06F 16/9574

(57) ABSTRACT

A non-transitory computer-readable storage medium having software instructions stored therein, which, when executed by a processor, cause the processor to segment content on a webpage or a software product, displayed on a display of a first electronic device, into a series of constituent components, display, on the display of the first electronic device, a gallery including a series of graphical elements representing the series of constituent components of the webpage or the software product, copy at least one constituent component of the series of constituent components in response to a selection input into the first electronic device, and transmit, to a second electronic device remote from the first electronic device, a signal configured to display, on a display of the second electronic device, the at least one constituent component copied in response to the selection input into the first electronic device.

### CROSS-REFERENCE TO RELATED APPLICATION(S)

The present application claims priority to and the benefit of U.S. Provisional Application No. 63/125,710, filed Dec. 15, 2020, the entire content of which is incorporated herein by reference. The present application is also related to co-pending U.S. application Ser. No. 17/325,662, filed May 20, 2021, the entire content of which is incorporated herein by reference, and which is not admitted to be prior art with respect to the present application by its mention in the cross-reference section.

### BACKGROUND

### 1. Field

The present disclosure relates to various embodiments of a system and method of embedding segments of a webpage.

### 2. Description of Related Art

Webpages are commonly shared between users by sending a link (i.e., a URL) to the webpage. However, sharing links typically requires the user to navigate away from the current page they are viewing. Additionally, users may not be able to access every link that is shared by another user. For instance, the content may be behind a paywall (i.e., the content may be available only to users who are paying a subscription fee) or may be accessible only to users who have an account. Furthermore, conventional methods of sharing a webpage permit a user to share only the entire webpage, rather than selected, relevant portions of the content on the webpage.

### SUMMARY

The present disclosure relates to various computer-implemented methods. In one embodiment, the computer-implemented method includes segmenting content on a webpage or a software product, displayed on a display of a first electronic device, into a series of constituent components. The method also includes displaying, on the display of the first electronic device, a gallery including a series of graphical elements representing the series of constituent components of the webpage or the software product. The method further includes copying at least one constituent component of the series of constituent components in response to a selection input into the first electronic device, and transmitting, to a second electronic device remote from the first electronic device, a signal configured to display, on a display of the second electronic device, the at least one constituent component copied in response to the selection input into the first electronic device.

The constituent components may be a graph, a table, a picture, text, a header, a video, or combinations thereof.

The method may also include navigating to the webpage or the software product in response to a command input into the first electronic device.

The method may include extracting data from the at least one constituent component, and re-rendering the data extracted from the at least one constituent component. The re-rendering of the data may include re-rendering the data in a different format.

The signal transmitted to the second electronic device may be configured to cause the display of the second electronic device to display a rendering of the at least one constituent component or a rendered screenshot of the at least one constituent component.

The method may also include refreshing the at least one constituent component displayed on the second electronic device. The refreshing may include comparing one or more attributes of the at least one constituent component to one or more Document Object Model (DOM) attributes of the webpage or the software product.

The present disclosure also relates to various embodiments of a non-transitory computer-readable storage medium. In one embodiment, the non-transitory computer-readable storage medium has software instructions stored therein, which, when executed by a processor, cause the processor to segment content on a webpage or a software product, displayed on a display of a first electronic device, into a series of constituent components, and to display, on the display of the first electronic device, a gallery including a series of graphical elements representing the series of constituent components of the webpage or the software product. The software instructions, when executed by the processor, also cause the processor to copy at least one constituent component of the series of constituent components in response to a selection input into the first electronic device, and to transmit, to a second electronic device remote from the first electronic device, a signal configured to display, on a display of the second electronic device, the at least one constituent component copied in response to the selection input into the first electronic device.

The constituent components may be a graph, a table, a picture, text, a header, a video, or combinations thereof.

The instructions, when executed by the processor, may further cause the processor to extract data from the at least one constituent component, and re-render the data extracted from the at least one constituent component to generate a re-rendering of the data. The re-rendering of the data may be in a different format than the data extracted from the at least one constituent component.

The at least one constituent component displayed on the second electronic device may include a rendering of the at least one constituent component or a rendered screenshot of the at least one constituent component.

The instructions, when executed by the processor, may further cause the processor to refresh the at least one constituent component displayed on the second electronic device.

The instructions, when executed by the processor, may further cause the processor to compare one or more attributes of the at least one constituent component to one or more Document Object Model (DOM) attributes of the webpage to refresh the at least one constituent component.

A non-transitory computer-readable storage medium according to another embodiment of the present disclosure includes software instructions stored therein, which, when executed by a processor, cause the processor to segment content on the webpage or the software product into a series of constituent components, display, on the first electronic device, a gallery including a series of graphical elements representing the series of constituent components, copy at least one constituent component of the series of constituent components in response to a selection input into the first electronic device, extract data from the at least one constituent component, re-render the data extracted from the at least one constituent component in a different format to generate a re-rendering of the data, and transmit, to a second electronic device remote from the first electronic device, a signal configured to display, on a display of the second electronic device, the re-rendering of the data.

The constituent components may be a graph, a table, a picture, text, a header, a video, or combinations thereof.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable system or method of embedding segments of a webpage.

### BRIEF DESCRIPTION OF THE DRAWINGS

The accompanying drawings, together with the specification, illustrate exemplary embodiments of the present disclosure, and, together with the description, serve to explain the principles of the present disclosure.

FIG. 1 is a schematic view of a system for embedding segments of a webpage or software product according to one embodiment of the present disclosure;

FIG. 2 is a schematic view of a display of an electronic display displaying a gallery of segments of a webpage or a software product;

FIG. 3 is a schematic view of a display of an electronic device displaying a “preview” of a selected one of the segments of the webpage or the software product according to one embodiment of the present disclosure; and

FIG. 4 is a flowchart illustrating tasks of a method of embedding segments of a webpage according to one embodiment of the present disclosure.

### DETAILED DESCRIPTION

Aspects of the present disclosure relate to various systems and methods configured to enable users to share selected portion(s) of a webpage or a software product by segmenting a webpage into its constituent components and presenting a gallery to a user to select one or more of the constituent components to be shared. In one or more embodiments, portion(s) of a webpage or a software product may be shared without having to navigate away from the current webpage or section of a software product that the user is currently viewing. Additionally, in one or more embodiments, the systems and methods of the present disclosure may enable a user to share portion(s) of a webpage or software product with another user that would not otherwise be accessible to that other user, such as if the content is behind a paywall (i.e., the content is available only to users who are paying a subscription fee) or if the content is accessible only to users who have an account.

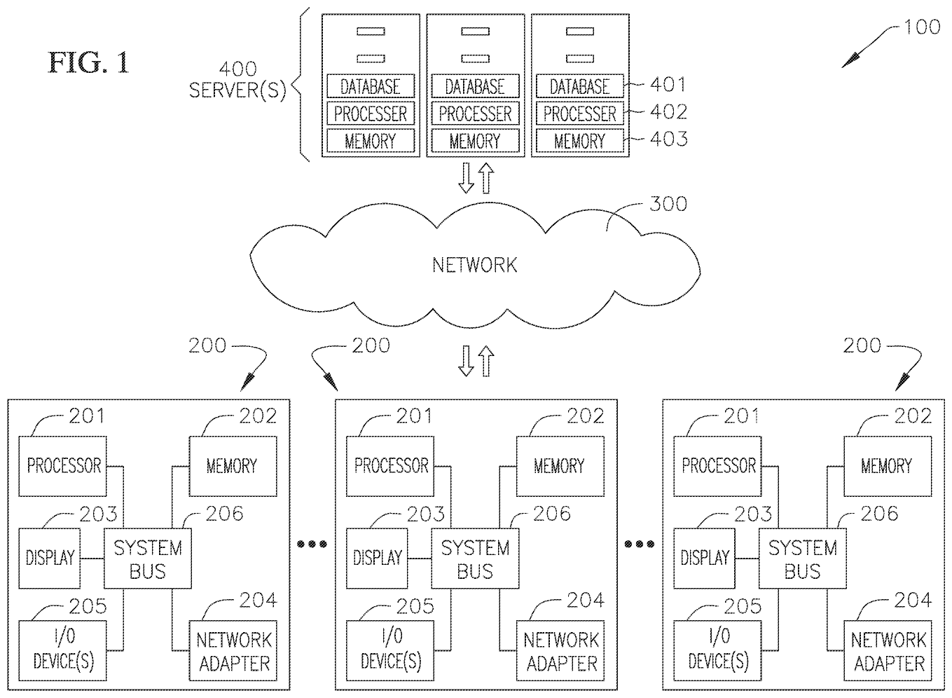

FIG. 1 is a block diagram of a system 100 according to one embodiment of the present disclosure. In the illustrated embodiment, the system 100 includes a series of electronic devices 200 (e.g., desktop computers, cellular phones, tablet computers, wearable electronic devices, or combinations thereof) connected to each other (i.e., configured to electronically communicate with each other) over a data network 300 (e.g., a local area network or a wide area network) via a server 400. In one or more embodiments, the electronic devices 200 may be operated by individuals (e.g., office personnel or other employees) who work for the same organization or related organizations. The number of electronic devices 200 connected to each other over the data network 300 via the server 400 may vary depending on the size of the organization or the sizes of the related organizations. As described in more detail below, the server 400 includes one or more software modules for facilitating and coordinating communications and interactions between the users of the electronic devices 200, such as when the users are utilizing the electronic devices 200 to view the same page or section (e.g., the same webpage) of a software product (e.g., software as a product (SaaP) or software as a service (Saas)).

In one or more embodiments, the server 400 includes a mass storage device or database 401 such as, for example, a disk drive, drive array, flash memory, magnetic tape, or other suitable mass storage device for storing instructions and information used by the server 400. For example, the database 401 may store personal profile information about the users, interactions between the users, interactions between a user and a software product, business/network data, and/or analysis results (e.g., processed data), amongst other data. In one or more embodiments, the database 401 may store any other relevant information for facilitating interactions between users of the electronic devices 200. Although the database 401 is included in the server 400 as illustrated in FIG. 1, in one or more embodiments, the server 400 may be connected to an external database that is not a part of the server 400, in which case, the database 401 may be used in addition to the external database or be omitted entirely.

The server 400 further includes a processor or central processing unit (CPU) 402, which executes program instructions from memory 403 and interacts with other system components to perform various methods and operations according to one or more embodiments of the present disclosure. The memory 403 is implemented using any suitable memory device, such as a random access memory (RAM), and may additionally operate as a computer-readable storage medium having non-transitory computer readable instructions stored therein that when executed by the processor 402 cause the server 400 to control and manage interactions and facilitate communications between the users using the electronic devices 200 over the data network 300.

In the embodiment illustrated in FIG. 1, each of the electronic devices 200 includes a processor 201, a memory device 202, a display 203 configured to display images, a network adapter 204 configured to communicate with other devices, including the server 400, and one or more input/output (I/O) devices 205 (e.g., a keyboard and a mouse). In the illustrated embodiment, the processor 201, the memory 202, the display 203, the network adapter 204, and the input/output (I/O) device(s) 205 communicate with one another over a system bus 206. In one or more embodiments, the memory 202 may include persistent memory, such as NAND flash memory, for storing instructions.

The term “processor” is used herein to include any combination of hardware, firmware, and software, employed to process data or digital signals. The hardware of a processor may include, for example, application specific integrated circuits (ASICs), general purpose or special purpose central processors (CPUs), digital signal processors (DSPs), graphics processors (GPUs), and programmable logic devices such as field programmable gate arrays (FPGAs). In a processor, as used herein, each function is performed either by hardware configured, i.e., hard-wired, to perform that function, or by more general purpose hardware, such as a CPU, configured to execute instructions stored in a non-transitory storage medium. A processor may be fabricated on a single printed wiring board (PWB) or distributed over several interconnected PWBs. A processor may contain other processors; for example, a processor may include two processors, an FPGA and a CPU, interconnected on a PWB.

As described in more detail below, the memory 403 of the server 400 and/or the memory 202 of the electronic devices 200 store instructions that, when executed by the processor 402, 201, respectively, cause the server 400 and the electronic devices 200 to perform various functions to facilitate collaboration between the users of the electronic devices 200.

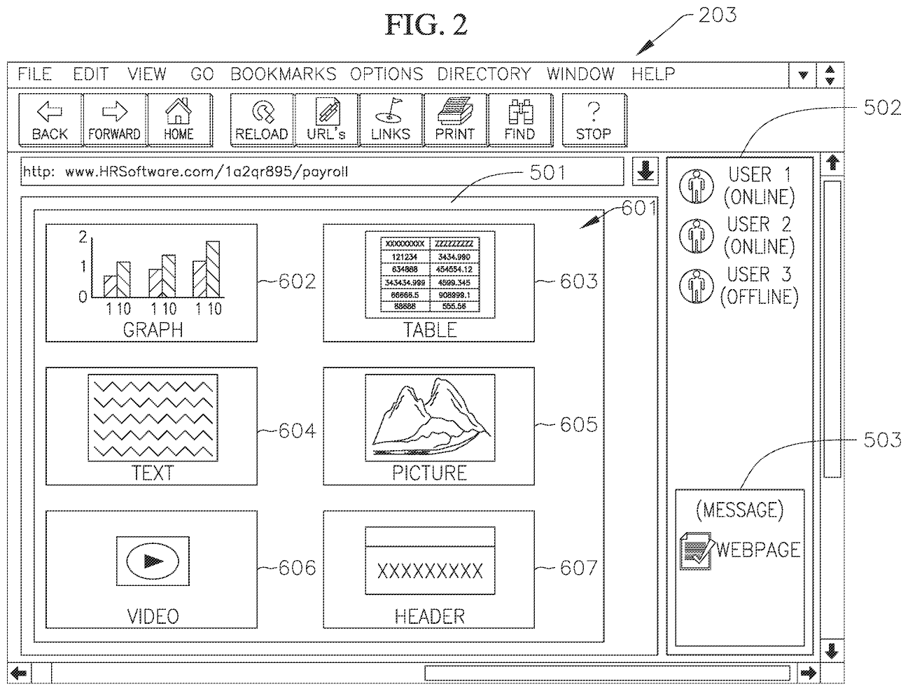

In one or more embodiments, instructions stored in the memory 202 of the electronic devices 200 and/or transmitted from the server 400 to the electronic devices 200, when executed by the processors 201 of the electronic devices 200, causes the displays 203 of the electronic devices 200 to display a page or section of a software product in a first iframe (i.e., a first HTML inline frame) and a user interface (e.g., a toolbar) including a message box in a second iframe adjacent to the second iframe (i.e., a second HTML inline frame). In one or more embodiments, the user interface may be displayed on the displays 203 of the electronic devices 200 that are being operated by two or more users who are affiliated with the same organization or two or more affiliated organizations and who are also viewing the same page or section of the software product. FIG. 2 depicts an exemplary embodiment of a display 203 of an electronic device 200 displaying a first window or iframe 501 displaying a viewport of a page or section of a software product (i.e., the user's visible area of the page or section of the software product), and a second window or iframe 502 adjacent or next to the first window 501 displaying a user interface (e.g., a sidebar) including a message box 503. As described in more detail below, the message box 503 of the user interface enables the users to collaborate and share files and other content (e.g., links to other pages of the software product or to a webpage; audio; video; pictures; other media files; documents; and executables).

In one or more embodiments, the memory 202 of the electronic device 200 operated by a first user includes instructions which, when executed by the processor 201, cause the electronic device 200 to navigate to and load a webpage when the first user enters a command into the first electronic device 200 (e.g., when the user enters a URL into a message box). The electronic device 200 may navigate to the webpage entered by the first user utilizing the web browser of the electronic device 200. FIG. 2 depicts a URL (e.g., www.example.com) that has been entered into the message box 503 of the user interface displayed in the second iframe 502.

In one or more embodiments, the instructions stored in the memory of the electronic device 200, when executed by the processor 201, cause the processor 201 to extract the content of the webpage (e.g., by web scraping) and to segment or segregate the content on the webpage into its constituent components (e.g., Document Object Model (DOM) elements containing graphics (images and/or videos), headers, tables, and/or charts). In one or more embodiments, the instructions may include a series of heuristics (e.g., a rules engine) configured to determine which components or elements of the webpage content to segment or segregate into separate components. In one or more embodiments, the instructions, when executed by the processor 201, may cause the processor 201 to classify the DOM elements of the webpage according to the individual DOM elements' placement within the hierarchy of the webpage. In one or more embodiments, the instructions, when executed by the processor 201, may cause the processor 201 to utilize natural language processing or any other suitable methodology or technique to derive informational content from the classified DOM elements, and to organize the analyzed DOM elements into a series of constituent components of the webpage according to the derived informational content of the individual DOM elements.

In one or more embodiments, the instructions, when executed by the processor 201, cause the electronic device 200 to display, on the display 203 of the first electronic device 200, a user interface including a gallery of graphical elements representative of the constituent components of the webpage, which were segmented or segregated in the manner described above. The gallery may be displayed in a pop-up window overlaid on the webpage or software product being viewed by the user (e.g., the gallery may be overlaid on the first iframe 501). In one or more embodiments, the gallery may be displayed in an iframe (i.e., an HTML inline frame). In the illustrated embodiment, each of the constituent components is selectable by the user (e.g., by clicking on the constituent components in the gallery utilizing the I/O device 205). FIG. 2 depicts a gallery 601 containing a series of graphical elements 602-607 arranged in an array in which each graphical element 602-607 represents and/or depicts one constituent component of the webpage according to one embodiment of the present disclosure. In FIG. 2, the gallery includes a first graphical element 602 representing a graph on the webpage, a second graphical element 603 representing a table of numerical values, a third graphical element 604 representing a block of text on the webpage, a fourth graphical element 605 representing a picture on the webpage, a fifth graphical element 606 representing a video on the webpage, and a sixth graphical element 607 representing a header on the webpage.

In one or more embodiments, the instructions, when executed by the processor 201, cause the processor 201 to save, in the memory 202 of the electronic device 200, the one or more constituent components of the webpage selected from the gallery by the user (i.e., the one or more constituent components of the webpage selected from the gallery by the user are cached in the memory 202 the electronic device 200). In one or more embodiments, one or more attributes associated with the selected component(s) of the webpage, such as the DOM attributes associated with the selected component(s) of the webpage (e.g., the depth of the selected component(s) in the DOM tree and/or the DOM class of the selected component(s)) may also be saved in the memory 202 of the electronic device 200 (i.e., the attribute(s) associated with the one or more constituent components of the webpage selected from the gallery by the user are cached in the memory 202 the electronic device 200).

Additionally, in one or more embodiments, the instructions, when executed by the processor 201, cause the electronic device 200 to transmit, from the electronic device 200 to the server 400 over the network 300 via the network adapter 204, a signal containing information regarding the one or more constituent components of the webpage selected from the gallery by the user. The information regarding the one or more constituent components of the webpage selected from the gallery by the user are saved in the memory 403 of the server 400 (i.e., the one or more constituent components of the webpage selected from the gallery by the user are cached on the server 400). The information transmitted to the server 400 may include the content of the one or more constituent components of the webpage selected by the user (e.g., video, images, text, etc.) and the attribute(s) (e.g., depth in DOM tree and/or DOM class) associated with the one or more constituent components of the webpage selected by the user.

In one or more embodiments, the instructions stored in the memory 403 of the server 400, when executed by the processor 402, cause the server 400 to transmit, to one or more of the other electronic devices 200 over the network 300, a signal containing information related to the one or more constituent components of the webpage. The signal, when received by the one or more electronic devices 200, causes the electronic devices 200 to display, on the displays 203 of the electronic devices 200, the information related to the one or more constituent components of the webpage. In one or more embodiments, the instructions contained in the signal transmitted by the server 400, when executed by the processor(s) 201 of the electronic device(s) 200, may cause the electronic device(s) 200 to display a rendering of the content (e.g., text, table(s), picture(s), and/or video(s)) selected from the gallery by the user. In one or more embodiments, the instructions contained in the signal transmitted by the server 400, when executed by the processor(s) 201 of the electronic device(s) 200, may cause the electronic device(s) 200 to display a rendered screenshot of the content selected from the gallery by the user. In one or more embodiments, the instructions contained in the signal transmitted by the server 400, when executed by the processor(s) 201 of the electronic device(s) 200, may cause the electronic device(s) 200 to display a re-rendering of data extracted from the content selected from the gallery by the user (e.g., extracted data from a chart and re-rendering it in a different style and with interactive controls, such as zoom, hover, etc.). In one or more embodiments, the re-rendering of the data includes rendering the data in a different format than the format in which data was rendered on the webpage (e.g., data displayed in a table on the webpage may be re-rendered as a chart).

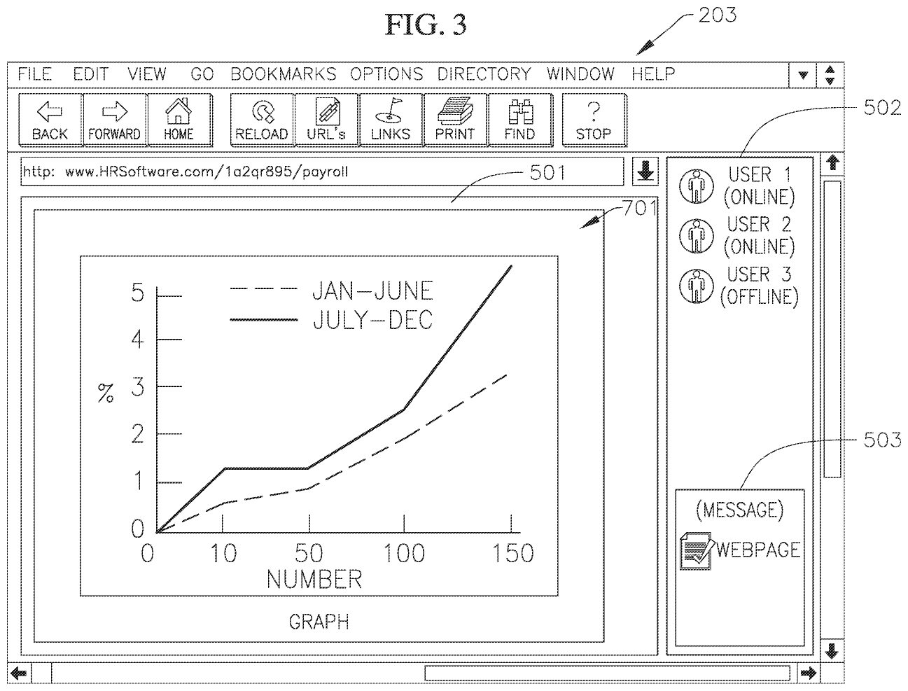

FIG. 3 depicts a “preview” 701 of a selected component (e.g., a chart) of a webpage displayed on a display of an electronic device according to one embodiment of the present disclosure. In the illustrated embodiment, the “preview” 701 of the one or more selected component(s) of the webpage are displayed in the first iframe 501 in which a viewport of a webpage or a page or section of a software product is displayed (e.g., the “preview” 701 of the selected component(s) of the webpage are overlaid on the viewport). Accordingly, as illustrated in FIG. 3, the user is able to view the “preview” 701 of the selected component(s) of the webpage without having to leave the current page or section of the webpage or the software product being viewed. In this manner, users are able to share a “preview” of the content from a webpage or a software product with other users without those other users having to navigate away from the webpage or the page of the software product they are currently viewing. In one or more embodiments, the “preview” 701 of the one or more selected components of the webpage may be displayed in the user interface of the second iframe 502 adjacent to the first iframe 501. Additionally, because the content of the webpage is retrieved by the requesting user's browser, other users are able to view content from a webpage in which they would not otherwise be able to view, such as if the webpage was behind a paywall and the other users have not subscribed to receive the content, or if the webpage requires an account to access the content and the other users do not have an account.

In one or more embodiments, when another user views the “preview” or the user views the “preview” at a later time, the instructions stored in the memory 202 of the electronic device 200, when executed by the processor 201, cause the electronic device 200 to navigate to the URL (i.e., access the URL) associated with the selected component(s) shared by the other user and to refresh the “preview” with the current information on the webpage. In one or more embodiments, the instructions stored in the memory 202 of the electronic device 200 or transmitted to the electronic device 200 from the server 400, when executed by the processor 201, cause the electronic device 200 to compare the attribute(s) of the selected component(s) to the attributes of the webpage (e.g., comparing the DOM attributes of the selected component(s) to the DOM attributes of the webpage, such as depth in the DOM tree and/or the DOM class) to determine the corresponding information on the webpage that is utilized to refresh the content of the “preview”. Accordingly, in one or more embodiments, the “preview” 701 of the selected component (e.g., the chart) depicted in FIG. 3 will be updated with the latest data from the webpage when another user views the “preview” 701 and/or when the same user views the “preview” 701 at a later time.

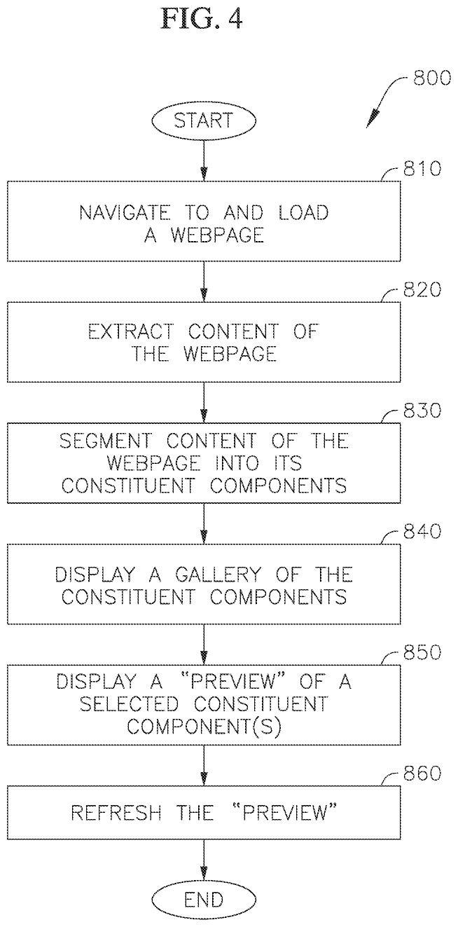

FIG. 4 is a flowchart illustrating tasks of a method 800 of embedding segments of a webpage or a software product and sharing those embedded segments with two or more electronic devices being operated by two or more users (e.g., two or more users of the same organization (or two or more affiliated organizations) who are viewing the same page or the same section of a software product (e.g., SaaP or SaaS product)). In one or more embodiments, the method 800 of the present disclosure may be performed utilizing a non-transitory computer-readable storage medium (e.g., computer memory) having software instructions (e.g., a software program) stored therein. The non-transitory computer readable storage medium and the software instructions stored therein are provided at two or more electronic devices (e.g., desktop computers, laptop computers, cellular phones, wearable electronic devices, or combinations thereof) operated by the users and/or at a server in electronic communication with the two or more electronic devices.

In one embodiment, the method 800 includes an operation 810 of navigating to and loading a webpage in response to a user command entered into an electronic device (e.g., entering a URL into a message box displayed on a display of the electronic device, as illustrated in FIG. 2). The operation 810 of navigating to the webpage may be performed utilizing the web browser of the electronic device.

In the illustrated embodiment, the method 800 also includes an operation 820 of extracting the content of the webpage (e.g., by web scraping or any other suitable method known or hereinafter developed).

In the illustrated embodiment, the method 800 also includes an operation 830 of segmenting or segregating the content on the webpage (which was navigated to in operation 810 and extracted in operation 820) into its constituent components (e.g., Document Object Model (DOM) elements containing graphics (images and/or videos), headers, tables, and/or charts). In one or more embodiments, the operation 830 may include applying a series of heuristics (e.g., a rules engine) to determine which components or elements of the webpage content to segment or segregate into individual components.

In the illustrated embodiment, the method 800 also includes an operation 840 of displaying, on a display being viewed by the user who entered the command (e.g., the URL into the message box), a gallery containing a series of graphic elements corresponding to the constituent components of the webpage that were segmented or segregated in operation 830 (e.g., an array of graphical elements representing a graph, a table, a block of text, a picture, a video, and a header of a webpage, as shown in FIG. 2). The gallery may be displayed in a pop-up window overlaid on the webpage or software product being viewed by the user. In one or more embodiments, the gallery displayed in operation 840 may be displayed in an iframe (i.e., an HTML inline frame). Each of the graphical elements in the gallery is selectable by the user (e.g., by utilizing an I/O device, such as a mouse or keyboard of the electronic device).

In the illustrated embodiment, the method 800 also includes an operation 850 of displaying, on a display of another electronic device, the one or more components or elements of the webpage selected from the gallery (displayed in operation 840) by the other user (i.e., displaying a “preview” of the component(s) of the webpage selected by the user). The operation 850 may include displaying one or more renderings of the content (e.g., text, table(s), picture(s), and/or video(s)) selected from the gallery by the user, one or more rendered screenshots of the content selected from the gallery by the user, and/or a re-rendering of data extracted from the content selected from the gallery by the user (e.g., extracted data from a chart and re-rendering it in a different style and with interactive controls, such as zoom, hover, etc.).

In one or more embodiments, the “preview” displayed in operation 850 may be displayed adjacent to other content displayed on the display. For instance, in one or more embodiments, the “preview” displayed in operation 850 may be displayed in an iframe (i.e., an HTML inline frame) adjacent to another iframe in which a viewport of a webpage or a page or section of a software product is displayed. Accordingly, in one or more embodiments, the user is able to view the “preview” of the selected component(s) of the webpage without having to leave the current page or section of the webpage or the software product being viewed. Additionally, because the content of the webpage is retrieved by the requesting user's browser in operations 810 and 820, other users are able to view content from a webpage in which they would not otherwise be able to view, such as if the webpage was behind a paywall and the other users have not subscribed to receive the content, or if the webpage requires an account to access the content and the other users do not have an account.

In one or more embodiments, the method 800 may also include an operation 860 of refreshing the “preview” displayed in operation 850 with the current information on the webpage (e.g., when another user views the “preview” or when the user views the “preview” at a later time). The operation 850 may include comparing the attribute(s) of the selected component(s) to the attributes of the webpage (e.g., comparing the DOM attributes of the selected component(s) to the DOM attributes of the webpage, such as depth in the DOM tree and/or the DOM class) to determine the corresponding information on the webpage that is utilized to refresh the content of the “preview” in operation 860.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described systems and methods of operation can be practiced without meaningfully departing from the principles, spirit, and scope of this invention, as set forth in the following claims, and equivalents thereof.

What is claimed is:

1. A computer-implemented method comprising:
segmenting content on a webpage or a software product, displayed on a display of a first electronic device, into a plurality of constituent components;
displaying, on the display of the first electronic device, a gallery comprising a plurality of graphical elements representing the plurality of constituent components of the webpage or the software product;
copying at least one constituent component of the plurality of constituent components in response to a selection input into the first electronic device; and
transmitting, to a second electronic device remote from the first electronic device, a signal configured to display, on a display of the second electronic device, the at least one constituent component copied in response to the selection input into the first electronic device.

2. The method of claim 1, wherein the constituent components are selected from the group consisting of a graph, a table, a picture, text, a header, a video, and combinations thereof.

3. The method of claim 1, further comprising navigating to the webpage or the software product in response to a command input into the first electronic device.

4. The method of claim 1, further comprising:
extracting data from the at least one constituent component; and
re-rendering the data extracted from the at least one constituent component.

5. The method of claim 4, wherein the re-rendering of the data comprises re-rendering the data in a different format.

6. The method of claim 1, wherein the signal transmitted to the second electronic device is configured to cause the display of the second electronic device to display a rendering of the at least one constituent component.

7. The method of claim 1, wherein the signal transmitted to the second electronic device is configured to cause the display of the second electronic device to display a rendered screenshot of the at least one constituent component.

8. The method of claim 1, further comprising refreshing the at least one constituent component displayed on the second electronic device.

9. The method of claim 8, wherein the refreshing comprises comparing one or more attributes of the at least one constituent component to one or more Document Object Model (DOM) attributes of the webpage or the software product.

10. A non-transitory computer-readable storage medium having software instructions stored therein, which, when executed by a processor, cause the processor to:
segment content on a webpage or a software product, displayed on a display of a first electronic device, into a plurality of constituent components;
display, on the display of the first electronic device, a gallery comprising a plurality of graphical elements representing the plurality of constituent components of the webpage or the software product;
copy at least one constituent component of the plurality of constituent components in response to a selection input into the first electronic device; and
transmit, to a second electronic device remote from the first electronic device, a signal configured to display, on a display of the second electronic device, the at least one constituent component copied in response to the selection input into the first electronic device.

11. The non-transitory computer-readable storage medium of claim 10, wherein the constituent components are selected from the group consisting of a graph, a table, a picture, text, a header, a video, and combinations thereof.

12. The non-transitory computer-readable storage medium of claim 10, wherein the instructions, when executed by the processor, further cause the processor to:
extract data from the at least one constituent component; and
re-render the data extracted from the at least one constituent component to generate a re-rendering of the data.

13. The non-transitory computer-readable storage medium of claim 12, wherein the re-rendering of the data is in a different format than the data extracted from the at least one constituent component.

14. The non-transitory computer-readable storage medium of claim 10, wherein the at least one constituent component displayed on the second electronic device comprises a rendering of the at least one constituent component.

15. The non-transitory computer-readable storage medium of claim 10, wherein the content displayed on the second electronic device comprises a rendered screenshot of the at least one constituent component.

16. The non-transitory computer-readable storage medium of claim 10, wherein the instructions, when executed by the processor, further cause the processor to refresh the at least one constituent component displayed on the second electronic device.

17. The non-transitory computer-readable storage medium of claim 16, wherein the instructions, when executed by the processor, further cause the processor to compare one or more attributes of the at least one constituent component to one or more Document Object Model (DOM) attributes of the webpage to refresh the at least one constituent component.

18. A non-transitory computer-readable storage medium having software instructions stored therein, which, when executed by a processor, cause the processor to:
segment content on the webpage or the software product into a plurality of constituent components;
display, on the first electronic device, a gallery comprising a plurality of graphical elements representing the plurality of constituent components;
copy at least one constituent component of the plurality of constituent components in response to a selection input into the first electronic device;
extract data from the at least one constituent component;
re-render the data extracted from the at least one constituent component in a different format to generate a re-rendering of the data; and
transmit, to a second electronic device remote from the first electronic device, a signal configured to display, on a display of the second electronic device, the re-rendering of the data.

19. The non-transitory computer-readable storage medium of claim 18, wherein the constituent components are selected from the group consisting of a graph, a table, a picture, text, a header, a video, and combinations thereof.
